(19) United States
(12) Patent Application Publication
(10) Pub. No.: US 2010/0294108 A1
(43) Pub. Date: Nov. 25, 2010

(54) STRING-STRIKING DEVICE FOR PIANO

(76) Inventor: Munshick Shin, Cheonan (KR)

Correspondence Address: EDWARDS ANGELL PALMER & DODGE LLP, P.O. BOX 55874, BOSTON, MA, 02205, US

(21) Appl. No.: 12/438,656

(22) PCT Filed: Jul. 2, 2007
(86) PCT No.: PCT/KR07/03192

§ 371 Date: Feb. 24, 2009

(30) Foreign Application Priority Data
Sep. 14, 2006 (KR) 10-2006-0088934

(51) Int. Cl. G10C 3/18

(52) U.S. Cl. 84/236

(57) ABSTRACT

This invention relates to a string-striking device for a piano which enables the adjustment of strength degrees more than at lest three, the moving interval between a hammer that is molding magnet and an excentricity rod is fixed piano body so that a player can choose freely from strength degree more then 3 comprising excentricity rod which is point a of the FIG. 7 point b of the FIG. 9 and a point from a to b of the FIG. 11.

### TECHNICAL FIELD

This invention relates to string-striking device for a piano which enables the adjustment of the piano-sound volume increase or decrease, applied upon the hammer assembly operation, to a long excentricity rod on the playing side of a key.

### BACKGROUND ART

Conventionally as seen in piano (100), it is a side view of a piano comprising a key (140) transmitting portion 160 and a hammer assembly portion (150). Conventionally as seen in FIG. 1 and FIG. 2, In order to adjust the piano-sound, applied upon the key depression, to a fore-end on the playing side of the key (140), the capstan(141) of the key is raised and the motion of the key (140) is transmitted to the transmitting portion (160) via the capstan screw.

The piano-sound is sensed by a player of the piano as the touch and feel of the key (140). Hereinafter, mainly only the piano-sound is an important parameter and how it is adjusted can determine whether the piano is considered good or bad. Thus the piano-sound should be adjusted with coution in accordance with the skill and taste of the player. Conventional piano is space A of an outer panel of the piano (100) only comprising a key transmitting portion (160) and a hammer assembly partion (150), In general a string for a lower note is thicker than a string for a higher note, Therefore a hammer (150) that strikes the string for lower note is made lorger and heavier than the hammer (150) for a higher note. When a key (140) is depressed by a player the capstan(140) of the is raised. The capstan(141) provided at the end of the key (140) together with the capstan button provided at the end of the capstan wire is also raised to transmit the motion of the key (140) to the hammer (150) to the transmitting portion (160). Simultaneously the key raises a wippen assembly (160) via contacting part. As a result the hammer (150) swings in the direction of the music wire (120) about the butt (154) until the hammer (150) hits the music wire (120). As the hammer strikes to swing in arrow direction FIG. 2 accordance with the depression of the key by the player, the piano-sound is generated from the music wire 120.

### DISCLOSURE OF INVENTION

### Technical Problem

However According to such for a piano (100) even if the moving mechanism is operated, the piano-sound (100) is changed a noise pollution to unconcern people who is no longer listened or heard. Without the string-striking device for the piano (300), it is trouble that a player who play freely the piano, residing next to each other, respectively have a different number of the rank (play the lesson) in a piano institute or a piano room by room there is a problem that none of the conventional pianos (100) adjust a volume of the piano sound. The present invention was made to solve these problem. one object invention is to provide a string-striking device for a piano (300) which allow easy adjustment of the piano-sound, applied to a fore-end on the playing side of a key.

In order to solve the above problems, a string striking device for the piano (300) according to the present invention is provided with a long excentric rod, striking accelerator rod, a magnet of the shank, a worm gear, wheel, a transmission rod, a belt and knob. a long excentric rod is disposed vertically direction of a segment, drawing between music wire (320) and a hammer (350). The long excentric rod is arranged such that one end thereof is fixed to a piano body so as to allow both axes of excentric rod to freely rotate in direction of a thin or thick side. The other end secured a belt (370) which can be rotate along transmission rod with worm wheel. As above, since the excentric rod applies a direction of a rotation on the excentric axis, the striking degrees of the hammer (350) can be adjusted by changing the direction of the excentric rod. Moreover, since the excentric rod is provided, the piano-sound can be variously changed. Thus a player can be choose freely the piano-sound powers more than at lest three.

In addition if the present invention is applied to an upright piano, the touch and feel similar to that of a grand piano can be obtained. This is because the motion of the striking accelerator rod (380) is similar to that of a hammer portion of the grand piano. Immediately after a player depresses a key, the corresponding a magnet of a hammer shank side moves in accordance with the motion of the key. When the player fully depresses the key and the motion of the key is stopped, the molding a magnet of the hammer shank moves independently away from the key by the accelerator rod (380).

### Technical Solution

However solely providing the excentric rod above the key in the aforementioned manner may cause the player to feel uncomfortable. Therefore it is preferable that the string-striking device is provided the striking accelerator rod (380) secured to the piano body and extending over a plurality of the molding magnet of hammer shank. The buried magnet of the accelerator rod speed up the striking power and the swing of the plurality of the hammers. With the striking accelerator rod (380) as above, appropriate adjustment of the time required for the hammer to return to a state in which the hammer strikes the music wire (320) again is possible by changing the set position of the magnet of the hammer shank. Furthermore a favorable touch and feel can be provided to the player. Adjustment of excentric rod can be conducted by changing the striking power of the hammer. The string-striking device (300) may be further provided with a moving mechanism that moves the excentric rod along the rotating direction of the knob. Thus a piano-sound volume may be adjusted by the moving mechanism that moves the excentric rod with respect to the knob. The reason why the adjustment of the piano-sound volume is accomplished by the moving of the excentric rod with respect to the hammer is that moving the excentric rod results in a change in a distance between the point of application of the excentric rod surface applied by the knob and the interval of the hammer shank. In this manner adjustment of the excentric rod can be done without replacement of the axes of the excentric, thus simplifying the work of adjusting the piano-sound volume.

On the other hand depending upon the age, taste etc. of player, there may be a situation in which the temporary removal of the piano-sound volume of the aforementioned the excentric rod by the knob. To readily meet this demand, it is preferable that the string-striking device is constituted as follow. That is the string-striking device (300) is provided with a belt that is disposed between the one end of axis of the excentric and a transmission rod so as to adjust the excentric rod by rotating the same for a normal position where the excentric rod surface can touch the hammer shanks and a holding position where the surfaces are separated from the hammer shanks. In the device constituted as above if the axis of the excentric rod is rotated up so that the hammers are brought to the holding position where the hammers do not touch the music wire, a situation is created where the interval of the hammer is no longer struck to the music wire. Conversely when the axis of the excentric rod is rotated down so that the hammers are also brought to the normal position where the hammers strike the music wire, a situation is created where the hammers is struck the music wire. The switching operation that rotated up and down the excentric rod may be conducted when an outer panel of the piano is removed. However it is preferable that the string-striking device is provided with a connecting member, one end of which is connected to the excentric rod and the other is brought out to the outside of the piano. The excentric rod can be displaced by operating the other end of the connecting member (belt) outside of the piano. If the string-striking device is constituted as such, the player does not need to take off an outer panel of the piano in order to switch the position of the excentric rod. Thus, this configuration is convenient. Also, the other end of the connecting member may be formed into adjusting the knob. In this manner the excentric rod can be adjusted in various ways during the play. Accordingly the piano of the present invention can produce a sound having strength or softness which could have never been produced by a conventional piano. The excentric rod may be rounded on the surface part where the excentric rod abuts on the hammer shank. However depending on the piano-sound of a desired volume, there may be situation in which excessive friction is produced between the excentric rod and hammer shank. Thus affecting the touch of the hammer shank. Therefore in order to reduce the friction between the excentric rod and the hammer shank, without changing the touch of the key, the part of the shank which abuts on the excentric rod may be made in form of a wedge shape that can prevent friction. Constituted as above, the friction between the contacting part of the excentric rod and hammer shank can be reduce. Moreover wear of the contacting part can be prevented. Also in the part of the hammer shank which abuts on the excentric rod, a excentric surface receiving mold may be provide on a shank of the hammer facing the rod surface, so that the hammer shank can be secured by a mold is wedge shaped. In this case a friction reducing layer may be provided on the surface of the shank facing the excentric rod. The friction reducing layer is made from a material that allows a frictional force to be smaller than a frictional force produced by direct contact between the rod receiving part and the shank of hammer. In another aspect of the present invention the string-striking device for the piano is provided with a long excentric rod extending over a plurality of the hammers a striking accelerator rod and a moving mechanism. The long excentric rod dispose along a horizontal direction of the hammer assembly above the side opposite to the playing side of the key. The excentric rod is arranged such that both end thereof is fixed to a piano body so as to allow the hammer to freely swing from normal position to a holding position. one long axis of the excentric rod which can be vertically displaced is brought into contact with a belt and applies its own belt to the lower direction of transmission rod. The striking accelerator rod is secured the piano body and extending over a plurality of the hammer shanks. The striking accelerator rod speed up the upward swing of the hammer shank secured a mold and is formed in such a manner that the center part thereof is buried a magnet as wedge shaped. The moving mechanism moves the excentric rod along B space FIG. 3 The excentric rod adjusting knob enables transmission rod move and is formed in such a manner that one long axis of excentric is secured the belt that is rotated. According to such a string-striking device for piano when the moving mechanism is operated to move the excentric rod along the length direction of hammer rail, the belt from the one axis of excentric rod to the part where the transmission rod is secured by the worm wheel is rotating. Accordingly the piano-sound volume applied to the knob the playing side of the key can be adjusted by operating the moving mechanism. In addition the upward swing range of the hammer, A piano-sound volume is generated in step by step whenever the excentric rod rotates by the knob, the piano-sound volume is transformed to increase sound or decrease sound.

### Advantageous Effects

None of a conventional piano displace the long excentric rod, the hitting controller of independent piano which can control the hitting string to one of at lest three degrees and the striking accelerator using a magnet of a hammer shank.

### BRIEF DESCRIPTION OF THE DRAWINGS

FIG. 1 is a side view showing a conventional string-striking device for upright piano according to a embodiment.

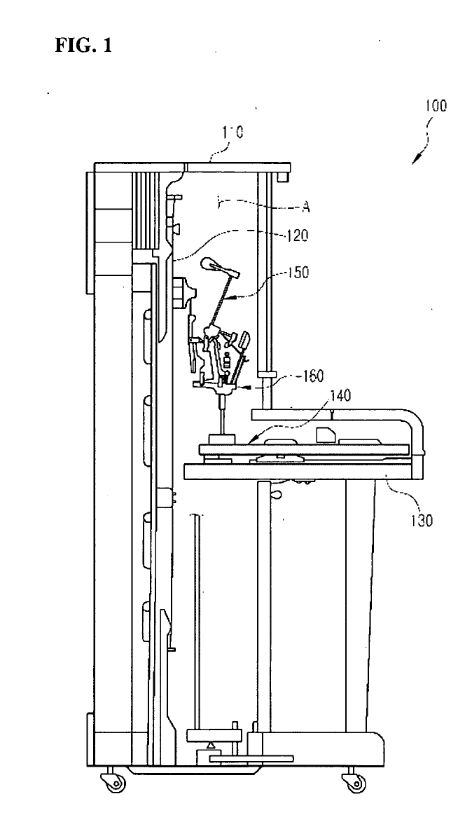

FIG. 2 is a perspective view showing the vicinity of space A of outer panel according to FIG. 1 according to a embodiment.

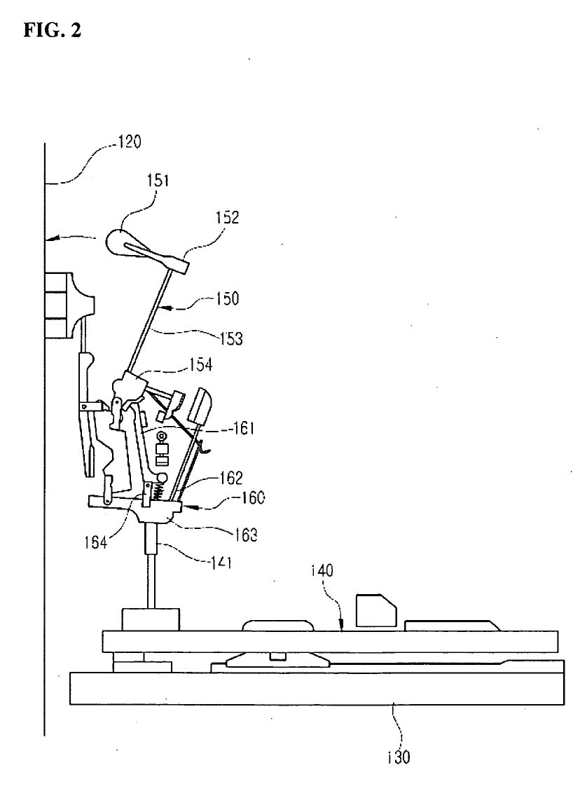

FIG. 3 is a side view showing a string-striking device for an upright piano according to first embodiment.

FIG. 4 is a perspective view showing the vicinity of space B of outer panel according to a short (thin) side for a magnet of the shank.

FIG. 5 is an overhead view showing a hitting control apparatus for the keyboard musical instrument.

FIG. 6 is a cross section showing the vicinity of an excentric rod according to the difference between point Z of an excentric axes and center point C of the rod.

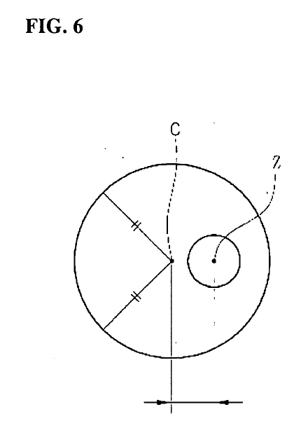

FIG. 7 is a perspective view showing the vicinity of a string-striking device for piano according to a key depression FIG. 4.

FIG. 8 to the contrary FIG. 4 is a perspective view showing the vicinity of space B of outer panel according to a long (thick) side for a magnet of the shank.

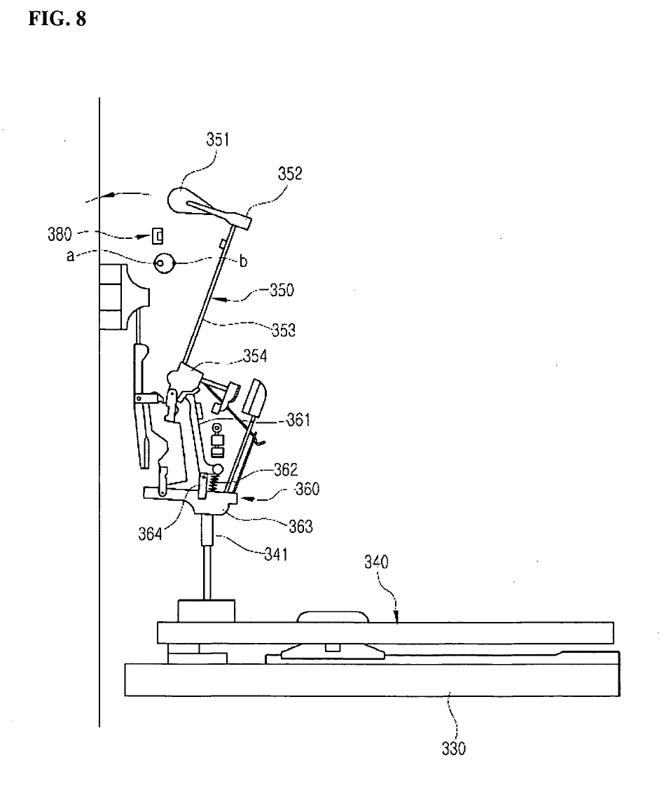

FIG. 9 to the contrary FIG. 7 is a perspective view showing the vicinity of a string-striking device for piano according to a key depression FIG. 8 applied upon the shank interruption.

FIG. 10 the excentric rod between FIG. 4 and FIG. 8 are a perspective view showing the vicinity of a string-striking device for piano according to adjust of the knob.

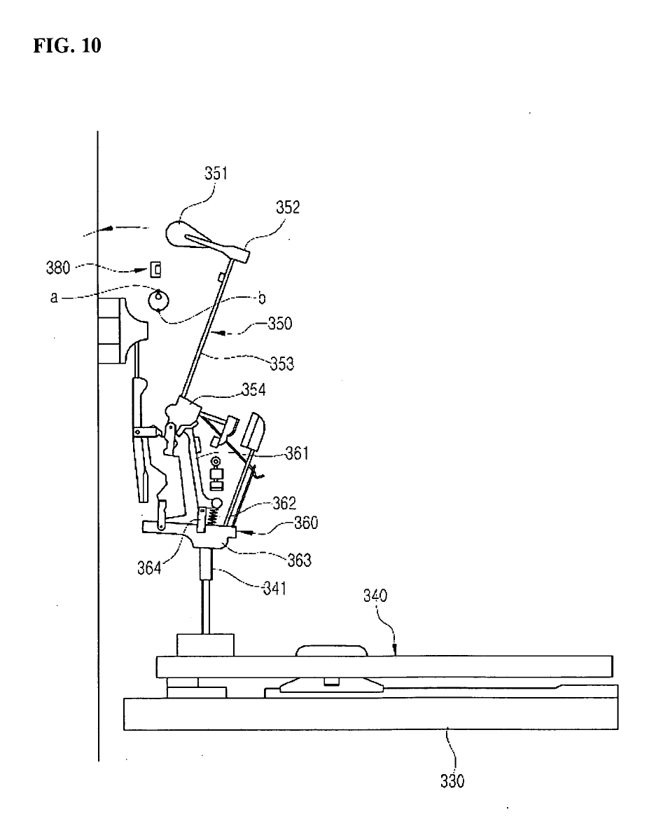

FIG. 11 the excentric rod between FIG. 4 and FIG. 8 are a perspective view showing the vicinity of a string-striking device for piano according to applied upon the interruption shank a little bit.

### BEST MODE FOR CARRYING OUT THE INVENTION

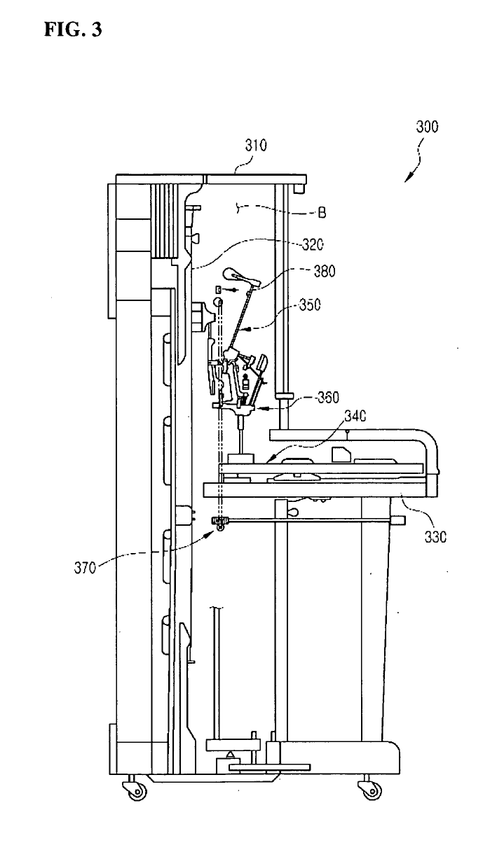

The best mode for carrying out the present invention will be described best below by the way drawings. FIG. 3 is a side view showing a string-striking device (300) for an upright piano. As shown in FIG. 3 the string-striking device (300) mainly comprises a key 340 a transmitting rod portion 370, and a hammer assembly portion (350). The string-striking device (300) convert the motion of a conventional piano, resulting from the depression of the key by the player, to the motion of the hammer portion striking a string. The piano has a total of 88 individual key (340). each key (340) arranged to pivot on an intermediate plate acting as a fulcrum. When a key 340 is depressed, the side opposite to the player side of the key (340) is raised to transmit the key depression to the transmitting portion (341). Particularly, the key depression is transmitted to the transmitting portion (341) and further to the hammer portion, via a capstan button (341) attached to The piano has a total of 88 individual key (340). Each key (340) is an end of a wippen assembly (360). The capstan(341) is provided at an end on the side opposite to the player side of the key (340). Hereinafter the player side of the key (340 right side) is referred to as a front side and the side opposite to the player side of the key (340 left side) is referred to as a rear side.

Above the rear side of the key 340, a long excentric rod (371) is provided which extends over a plurality of the hammer shanks. Both ends of excentric rod (371) is fixed to the piano body by rod of axes (not shown). Additionally at both ends of the excentric rod two bearings are provided (not shown). The upper part of the excentric rod is provided the striking accelerator rod which is fixed to the piano body in its parallel. Furthermore one axis of the excentric rod is secured a belt (370) with the transmission rod (373) provided in the lower part of the knob (372a). the other of the excentric rod is rotatably fixed to the piano body. Thus the striking accelerator rod (380) is arranged in parallel to the excentric rod so that a marget of striking accelerator pull a marget of the shank when the key 340 is depressed.

Once a worm wheel is provided on one end of the transmission rod (373a) so as to adjust the desirable sound generated when the hammer (350) hits the music wire 320. on the other hand at the upper side of the transmission rod, a occluding worm gear is provided which adjusts a knob. Also at the occluding worm gear (372b) the rod of the adjustment 372 is provided to control the knob (372a).

Below the rear side of the belt 374 is provided for each axis of excentric rod and transmission rod, one end for the rods each to each.

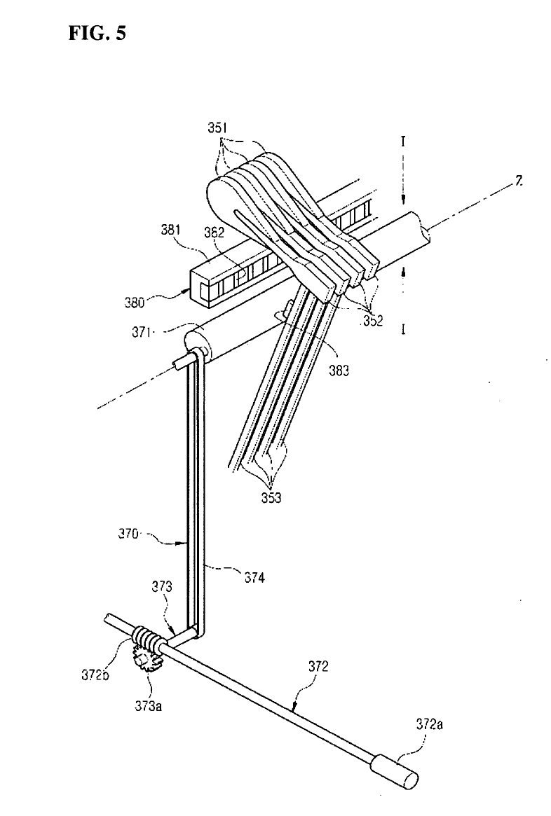

FIG. 5 is an overhead showing of the belt 374. as shown in FIG. 5 the belt is secured at, each to each, end of the axes encentric rod and transmission rod provided along arrangement direction of the adjustment rod 372. The belt is fixed rotatably to the axis of excentric via the knob (372a) in substantially the same manner as the excentric rod. Below one end of the belt, the transmission rod (373) is provided which extend upward adjusting the knob.

The contacting side of hammer shank is covered with a mold (wedge shape) for easing the shock caused when the hammer shank hits the excentric rod. in the upper end of the shank, a magnet is provided in the projected manner. in the center of the mold, a wedge shape for layer is provided.

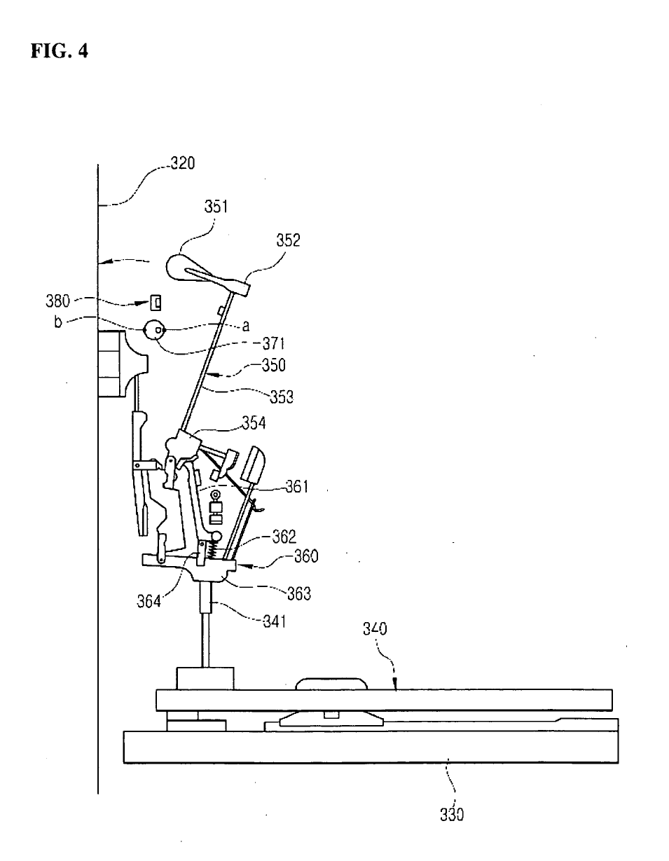

When a key (340) is depressed by a player the rear side of the key (340) is raised. the screw (341) provided at the end of the key together with the capstan wire provided the end of the capstan screw 341 is also raised to transmit the motion of the key (340) to the transmitting position (360). Simultaneously the key (340) raised a wippen assembly (360) via capstan screw (341). As a result the wippen assembly rises a jack flange (361) so that the hammer (350) swings in the direction of the arrow FIG. 4 about a music wire until the hammer felt (351) hits the music wire (320). once the hammer stops motion, and then due to gravity rotates in a direction opposite to arrow FIG. 4 about the hammer shank.

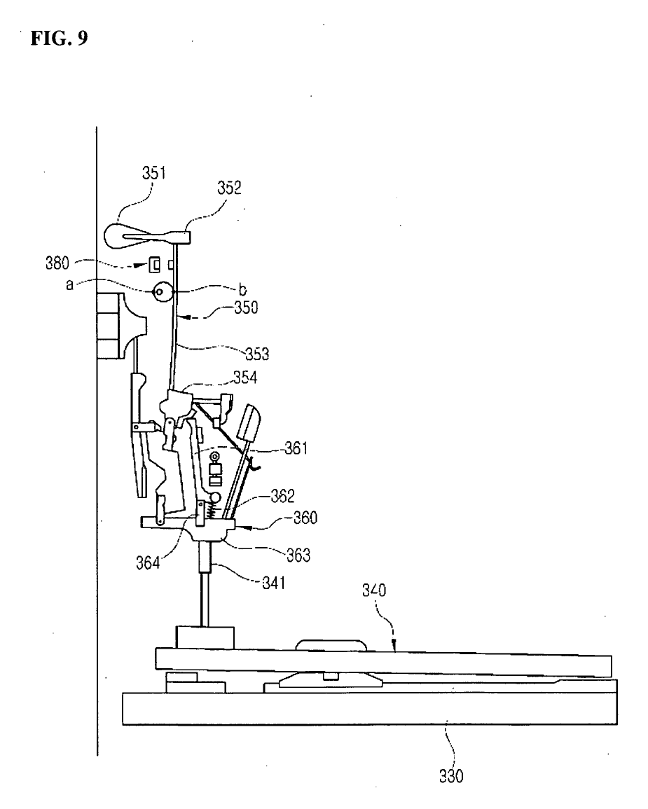

Additionally by rotating the aforementioned not shown the knob (372a) to the right side, the transmission rod (373) rotates in the direction from point a of the excentric rod to point b of excentric rod. The result is that even if a key is depressed a hammer felt (351) does not contact the part of the music wire (320) FIG. 9.

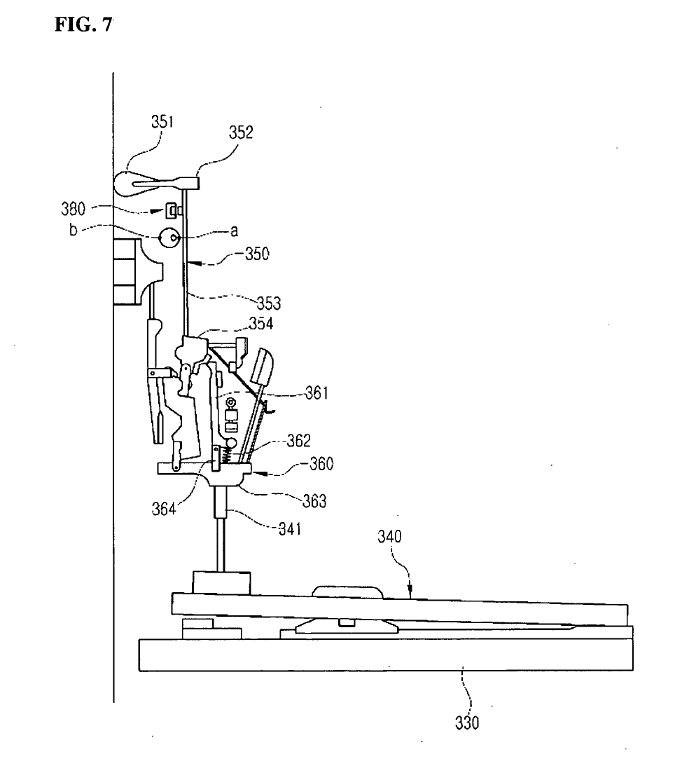

To the contrary by rotating the knob to the left side the excentric rod (371) rotates in the direction opposite from point b of the excentric rod surface to point a of the excentric rod FIG. 7. The result is that even if the key is depressed, the hammer felt 351 strikes of the music wire (320). Hereinafter the piano-sound volume is determined as strike as contacting part of the excentric rod.

FIG. 4 is perspective view showing the vicinity of FIG. 3 in direction of arrow B space by rotating of the playing side, The short side (point a) of the excentric rod displaces in a space between the hammes shauks (353) and the music wire (320) applies freely the hammer shanks, Casing the hammer to swing without interruption and to be generated the piano-sound fully.

The result is that even if a key is depressed the hammer shank does not contact the excentric rod surface FIG. 7.

To the Contrary by rotating the knob to the rear side, the long side (point b) of excenteic rod is rotated in the direction of the hammer shank (353) so as to interrupt the hammer, thus strike not at all and to be quit piano-sound

The result is the hammer shanks are brought into contact with the excentric rod surface FIG. 9.

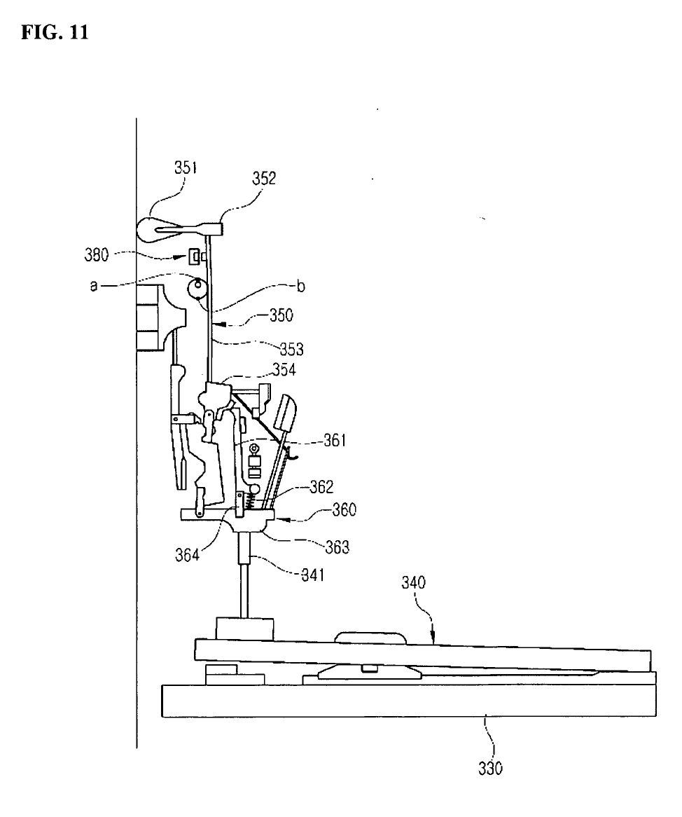

Additionally FIG. 11 is perceptive view showing the vicinity of the FIG. 3 in direction of arrow B case by adjusting the know side by side. a side (point a) of the excentric rod is vertically fixed to a striking accelerator rod (380) so as to hit the hammer shank a little bit, causing the hammer shank to touch and decrease the piano-sound. the result is that even if a key depressed, the hammer shanks is as contecting as a surface of the excentric rod FIG. 11 only the hammer strikes on the music.

In the string-striking device 300 constituted as such along horizontal direction, an extric rod is provided extending between the hammer is fixed to butt 354 and the music wire. With the about direction of the excentric rod, a striking accelerator rod is provided in front of the magnet of the shank 353 so as to speed up the hammer. Therefore even if a key depressed the key is smoothly operated, A favorable touch and feel can thereby be obtain.

As shown in FIGS. 3 and 4 are the space B casing of the string-striking device 300 is different with the space A casing of the conventional piano 100. Once the excentric rod 371 is arranged to extend to the rear side rotating about both axes of the excentric rod. Additionally the striking accelerator rod and others are disposed in accordance with the arrangement of the string-striking device for the piano (100). Moreover one axis of the excentric rod is designed to be secured by a belt provided on the transmission rod which is worm wheel. the excentric rod can be adjusted by being screwed into or loosened out of the knob. the other axis of the excentric rod is fixed the piano body.

The belt 374 is supported by rod-like rail supporting members (370), (373) and (372), provided at both ends and at several intermediate position of the belt (374). Additionally the belt supporting members FIG. 5 are respectively fixed to upper and lower the excentric rod. Therefore, only one example is described in the following.

The belt (374) is disposed in one axis of the excentric rod (371) and below the aforementioned rod supporting members (372) and (373). the belt is comprised of the upper rod (371). and the lower rod (373). Thus, the worm wheel (373a) is set to the worm gear (372b) of adjustment rod FIG. 5.

When a player rotates the knob (372a) in direction of the right side, the adjustment rod (372) rotates to the rear side of the piano. Along with the worm gear (372b) of adjustment rod, the rod supporting member 373a, transmission rod (373), belt (374) and excentric rod (371) are all moved to the rear side. Also when the player rotates the knob (372a) in direction opposite of the left, the upper rod (371) rotates to the front side of the piano. Along with the worm gear (372b), the rod supporting members are all moved to the front side.

In this manner as the player operates the knob, a position of the excentric rod, etc. can be changed. Alone with the change of the position, the operating point of the excentric rod moved. As a result, successive adjustment of the piano-sound volume applied to the key is possible.

Furthermore since the string-striking device is designed to work together by operating only the knob 372a, all the hammers can be moved uniformly.

### MODE FOR THE INVENTION

As above change in the interval by the positional change of the excentric rod (371) between the position a and the position b side by side. Accordingly with respect to the position from the position a to the position b, the adjustment of a interval can be closely performed by the position of the excentric rod (371). Therefore if the interval of the excentric rod and the shank (353) are properly set, the adjustment range of the interval suitable for normal play can be closely adjusted according to the player's taste. Moreover, the adjustment range of the interval for the piano volume can be performed to a large extent.

### INDUSTRIAL APPLICABILITY

The present invention can provide a string-striking device for a piano-sound which permits easy adjustment of the knob, applied to a fore-end on the playing side of a key such that industrial applicability is able to relate to a keyboard musical instrument comprising a long excentric rod (371), a striking accelerator rod (380), and a magnet, and a hitting control apparatus for the keyboard musical instrument.

### SEQUENCE LISTING

The string-striking device for a piano-sound, where acting between an excentric rod on the knob can be easily adjusted, a hammer on a fore-end on the playing side of a key. A long excentric rod is provided on the plurality of the hammers. The excentric rod is installed along the width direction of the key, in an upper space B FIG. 3 on the side opposite the playing side of the key. The installation is made such that one end of the excentric axis is horizontally displaceable long-end side of the excentric axis is connected with a belt of the transmission rod by its own rotation to apply a rotation on the knob. Accordingly the present invention can control the hitting strength to one of at lest threes.

1. The string-striking device for piano comprising a long excentricity rod (371) which is disposed vertically direction of a segment, drawing between music wire (320) and hammer shank (353) arranged such that the excentricity rod (371) is fixed to a piano body so as to allow the excentricity with the axis of rotation freely rotate both up and down, in order to adjust a piano-volume, the modulation which can be rotate both direction by the knob (372a).

2. The string-striking device for a piano according to claim 1 further comprising transmission rod that is secured to the piano body in transmission rod extends over the belt (374) and adjustment rod (372) by adjustment the knob (372a).

3. The string-striking device for a piano according to claim 2 further comprising a moving mechanism that moves the excentricity rod along transmission rod (373) of adjustment rod (372) and in order to enable a piano volume, adjust strength degrees more than 3 when a hammer of hammer assembly strike music wire (120).

4. The string-striking device for a piano according to claim 1 further comprising adjustment of moving interval of hammer shank that is moved between transmission of wippen assembly (360) and depression of the key (340).

5. The string-striking device for a piano according to claim 4 adjustment device (370) further comprising adjustment device (370) which is rotated a long excentricity rod with axis of rotation that is disposed between music wire and hammers shank so that adjustment device extends over from a long excentricity to adjustment the knob (372a) and is fixed to the piano body in such a manner that, by rotation of excentricity rod, the excentricity axis enables adjustment interval of the shank of the hammer from normal position where the shank of hammer can touch excentricity rod to a holding position where the shanks are separated from the a long excentricity rod by the rotation of axes of the excentricity.

6. The string-striking device for a piano according to claim 5, further comprising a connecting member, adjustment rod 372 which being rotated by the player and transmission device 370 extending outside the piano wherein the transmission rod 373 can be displaced by operating the volume-knob 372a. the other end of the connecting member outside the piano.

7. The string-striking device for a piano according to claim 6 further comprising a striking accelerator rod 380 picked up speed of a hammer of the hammer assembly.

8. The string-striking device for piano according to claim 7, the hammer assembly comprising hammer felt that strike directly music wire. Hammer wood that hold hammer felt and shank. further A striking-accelerator 380 comprising a striking-accelerator rod that display between music wire and hammer shank that is secured a magnet.

9. The string-striking device for piano comprising a long excentricity rod which is disposed vertical direction of a segment, drawing between music wire and hammer shank, and which is arranged such that the excentricity rod of both axes is arranged fixed to a piano body so as to allow the excentricity rod freely can be rotate up and down direction and one end of excentricity is fixed to a piano body (not shown action).

10. The string-striking device for a piano comprising according to claim 9, a long excentricity rod is replaced to a pipe which insert between magnet rod (striking-accelerator) it is into one that between excentricity rod and striking-accelerator so that enable the adjustment of interval between hammer shank and excentricity rod which is replaced pipe rod which enables the adjustment of magnetic force between excentricity rod and a hammer shank holding magnet so as to touch and feel by player.

11. The string-striking device for a piano comprising according to a long excentricity rod is replaced to a pipe which insert between striking accelerator rod and excentric rod. in order to decrease friction between the excentric rod and the hammer shank, applied on a cushion of the hammer shank and changed from a magnet of the hammer shank to a iron of the hammer.
